(19) United States
(12) Patent Application Publication
(10) Pub. No.: US 2014/0143160 A1
(43) Pub. Date: May 22, 2014

(54) RENTAL SERVICE PROVIDER MESSAGING SYSTEM

(71) Applicant: Kenneth James Hough, Cleveland (AU)

(72) Inventor: Kenneth James Hough, Cleveland (AU)

(21) Appl. No.: 14/087,155

(22) Filed: Nov. 22, 2013

(30) Foreign Application Priority Data
Nov. 22, 2012 (AU) 2012254936

(51) Int. Cl. G06Q 30/06

(52) U.S. Cl. CPC G06Q 30/0645
USPC 705/307

(57) ABSTRACT

Disclosed is a rental service provider messaging system comprised of a system database configured to receive registration details of rental service providers. The database is configured for the registered rental service providers to enter details of clients required to contact the rental service provider. The client details include particulars of predetermined acceptable government-issued identification associated with that client and is also configured to be searched by any registered rental service provider when initially engaging with a client for any recorded entries for that client. The search includes the particulars of details of predetermined acceptable government-issued identification of the client. The database is also configured to electronically message the registered rental service provider that listed the client on the database if the client is revealed in the database search. The electronic message advises the rental provider of predetermined details of the client initially engaging the services of another rental service provider.

### FIELD OF THE INVENTION

The present invention relates to a client messaging system and, in particular, to a rental service provider messaging system.

The invention has been developed primarily for use where the tourist service providers vend temporary accommodation such as hotels, hostels and caravan parks and will be described hereinafter with reference with this application. However, it will be appreciated that the invention is not limited to these uses and is applicable to any rental service provider such as vehicle rental and equipment & furniture hire, for example.

### BACKGROUND OF THE INVENTION

Accommodation providers to tourists regularly suffer financial losses caused by the actions of their clients. Often, the client causing damage cannot be economically tracked down to address any losses by the accommodation service provider, particularly to clients who are transients or foreign nationals. The losses and damage that can be suffered by tourist accommodation providers include loss of rent, dishonored checks, reversed credit card payments, stolen items, damaged items, disturbances causing losses in occupancy of adjacent accommodations and resulting damage to reputation. The loss and damage also extends to assault on or thefts from other clients.

In limited and unstructured ways, some individual businesses or franchises are known to alert each other by telephone or the like of damage caused by previous clients. The success rate in tracking such offenders is in practice very low and most temporary accommodation providers accept these losses are not generally recoverable. The problem is exacerbated if delinquent clients become aware that their damaging behaviour will go unaddressed in many circumstances.

It will be appreciated that whilst some franchises or the like have attempted to identify those delinquent clients who have caused losses, those clients merely need to go to another franchise or type of accommodation For example, a delinquent having damaged a hotel and then moving to a youth hostel or caravan park. In a common example, a client may be delinquent through lack of payment of rent at a caravan park and then may obtain accommodation at a backpacker hostel or camp ground or even rent a campervan or the like and these accommodation providers are ignorant of any delinquent history of their client. It is also noted that a delinquent accommodation client may also rent a flat or temporary accommodation or even hire a houseboat or a yacht. It is not known for operators of these segments to communicate with each other. Typically, such accommodation providers are represented by independent industry associations such as the Australian Hotels Association or Youth Hostels of Australia, for example.

This is generally true for rental service providers where there are no mechanisms to allow clients having unresolved issues with the provider to be followed up. It is to be understood that this allows the rental service provider to follow up not only where the client is a tourist or of no fixed address but also to those who simply do not wish to resolve those issues. Accordingly, there is a need for a rental service provider messaging system to allow a rental service provider to be alerted to, or alert others to, a listed client.

### SUMMARY OF THE INVENTION

In accordance with a first aspect of the present invention there is disclosed a method of providing a rental service provider messaging system, the method comprising the steps of:
establishing a system database to receive registration details of rental service providers;
providing an interface for said registered rental service providers to enter details of any client required to contact said rental service provider wherein listed client details include particulars of predetermined acceptable government issued identification associated with that client;
configuring said database to be searched by any registered rental service provider when initially engaging with a client for any recorded entries for that client, said search including the particulars of details of predetermined acceptable government issued identification of the client; and
if said client is revealed in said database search, configuring said database to electronically message said registered rental service provider having listed said client on said database and advising said searching rental tourist service provider predetermined details of said client engaging the services of the searching rental tourist service provider.

According to another aspect of the invention there is provided a rental service provider messaging system comprising:
a system database configured to receive registration details of rental service providers;
configuring said database for said registered rental service providers to enter details of any client required to contact said rental service provider wherein listed client details include particulars of predetermined acceptable government issued identification associated with that client;
configuring said database to be searched by any registered rental service provider when initially engaging with a client for any recorded entries for that client, said search including the particulars of details of predetermined acceptable government issued identification of the client; and
configuring said database to electronically message said registered rental service provider having listed said client on said database if said client is revealed in said database search, said electronic message advising said searching rental tourist service provider predetermined details of said client engaging the services of the searching rental tourist service provider.

It can therefore be seen that the method and system advantageously allows a register to be kept of listed clients with any unresolved issues with a provider and the system can electronically message a provider to alert them that a client they listed is attempting to obtain services from another provider. This can be carried out substantially in real time and also allows the provider who listed the client on the database to know the other provider and their location. Also, it can be that the method and system can also alert the provider searching the database when the client is initially engaged and this may include details of the provider listing the client or the reason the client is listed, as well as details of the listing provider to pass on to the client when initially engaging with the provider searching the database.

### BRIEF DESCRIPTION OF THE DRAWINGS

A preferred embodiment of the invention will now be described, by way of example only, with reference to the accompanying drawings in which:

FIG. 1 is a schematic block diagram of a tourist service provider messaging system according to the preferred embodiment; and

FIG. 2 is an example of a message sent to a provider by the system of FIG. 1.

### DETAILED DESCRIPTION OF THE PREFERRED EMBODIMENTS

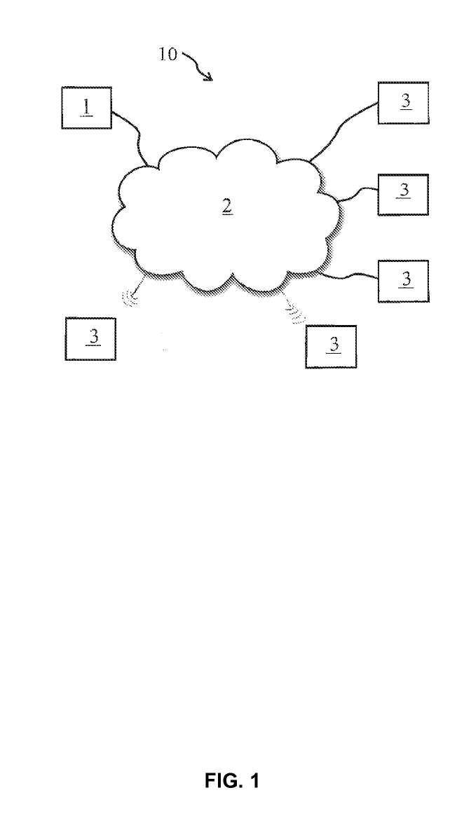

Referring to FIG. 1, a rental or hire service provider messaging system 10 is provided. The system 10 is described with reference to tourist service providers such as temporary accommodation providers. However, it will be appreciated that in other preferred embodiments (not illustrated) the tourist service provider could be any preferred rental or hire service provider such as, for example, providers of accommodation including houses, flats/apartments, caravan parks, hotels, motels, hostels, and boarding houses; or motor vehicle or motorcycle rental providers; boat hire providers; bicycle hire providers; or clothing and sporting and recreational equipment rental operators for example. Of course, this may extend to cellular telephone device or account rental, for example, and the system 10 is not limited to any specific application. A hire/rental provider as used herein rents, hires, leases or loans goods or services to a client.

The system 10 includes a database 1 that is accessible via the internet 2. The database 1 is formed from one or more interconnected computers having associated processors and RAM, ROM, hard drives and/or other memory. A modem connects the database 1 to the internet 2. The database 1 is accessible to tourist service providers 3.

Particularly, the database 1 is configured to receive registration details of tourist service providers 3. Most preferably, a tourist service provider 3 can register with the system 10 via an internet web-browser using one or more online forms. The tourist service providers 3 preferably elect an economic region which is relevant to their location. For example, continental Europe, North America, East Asia, sub-Saharan Africa or Oceania.

A database interface is provided for the registered tourist service providers 3 to be able to enter details of any delinquent client that is required to contact the listing tourist service provider as regards any loss or damage believed to be suffered by the listing tourist service provider 3. Although a delinquent client is described, this is for exemplary purposes only. The client, however, may have an unresolved issue with the provider that may or may not be related to delinquency or damage or the like such as to return goods left by the client at the accommodation.

When listing the delinquent client on the database 1, the listing tourist service provider 3 includes at least details of particulars of predetermined identification associated with the client of the delinquent client. These details are presented to the tourist service provider 3 when the client/tourist engages the services of the tourist service provider. The identification acceptable to the system 10 is that which is not easily corruptible and issued by a government authority. In the preferred embodiment, the listing tourist service provider 3 enters the delinquent client's passport number, driver's license number, or the official number of a government issued identity document. An example of such an identification document is, for example, a NSW Photo Card issued by the New South Wales government to persons not having a driver's license.

The database 1 is also configured to receive any other relevant information such as known aliases or photographs of the delinquent client. Furthermore, the database 1 is preferably configured to determine and list common misspellings or abbreviations, or to receive these from a client. For example, Jonathan, Jack, Jon and John.

The database 1 is configured to be searched by any tourist service provider 3 that is registered with the system 10 when initially engaging with a client. As part of the process of the client initially engaging the tourist service providers 3 services, the tourist service provider 3 searches the database 1 for any recorded entries to that client. The search undertaken by the tourist service provider 3 includes those predetermined acceptable government issued identifications above. Names are also able to be searched. If the tourist service provider 3 is registered on the system 10 with a selected economic region, then the searching on the system 10 may be limited to entries for clients in that region.

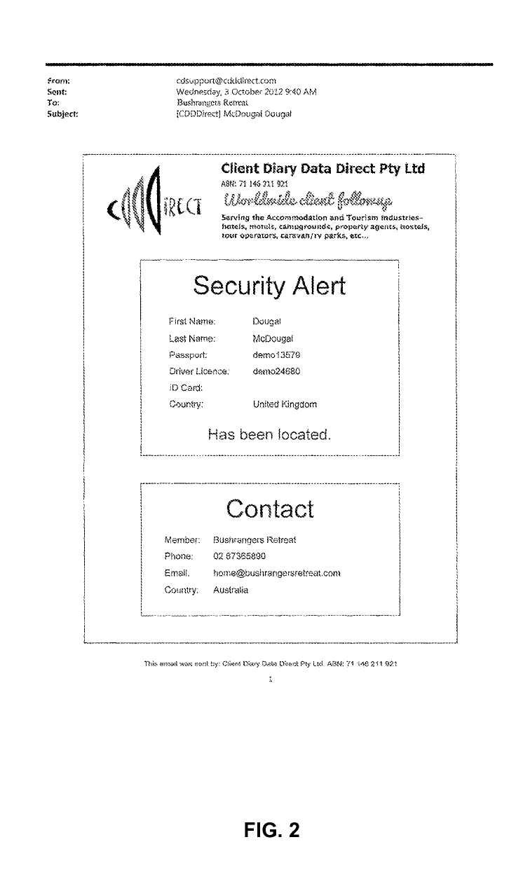

If the client attempting to engage the services of the registered tourist service provider 3 searching the database 1 is listed thereon for example as delinquent, the system 10 is configured to automatically send an electronic message to the registered tourist service provider 3 that listed the client as delinquent on the database 1. FIG. 2 is an example of an email or MMS message that could be sent to either or both the listing tourist service provider's email or telephone as preferred. In the preferred embodiment, the message sent to the listing tourist service provider 3 includes any known name details of the client as well as the particulars of one or more (two in the embodiment of FIG. 2) acceptable government issued identification numbers.

Importantly, the message to the listing tourist service provider 3 includes contact details of the tourist service provider 3 that is checking-in the delinquent client and causing the message to be sent. In the preferred embodiment of the message form shown in FIG. 2, the name of the tourist service provider 3, their location and contact details are provided to the listing tourist service provider 3 in the message. It can be seen therefore that the system 10 advantageously sends an automated message if a former client who has done damage that has not been accounted for if that client attempts to engage tourist services from another provider, the former listing tourist service provider will know their whereabouts and can take any action they desire accordingly.

This may be to telephone a local law enforcement agency when the client is delinquent such as when serious damage or assault, for example, has occurred. However, it may be to simply contact the provider that has searched the database to pass on a message or obtain a postal address for the listed client.

Although not illustrated, the system 10 can also advantageously display details to the searching provider and/or also send them an automated electronic message or otherwise indicate through the database 1 that their search revealed a listing of the delinquent client trying to engage their services. It will be appreciated that any preferred details can be provided ranging from a simple notification of the client's listing on the database through to details of the listing tourist service provider 3 and particulars of the reasons for listing the client.

When particulars of the listing of the client on the database are provided to the tourist service provider 3 whose services are being engaged that provider may choose to advise the client of their listing, not to mention the listing or to use of that information to influence any decision to provide any services to that client. In any event, the system 10 provides a means to the tourist service providers 3 to not only track down delinquent clients that would otherwise be uncontactable but also to allow potential service providers to become aware of any delinquent history when initially engaging a client. This is a significant advance allowing the tourist service providers 3 to follow-up on any damage but can also act to alert potential providers of service to a delinquent client, deter clients from causing loss or damage or allow a client to address an alleged delinquency. It will be appreciated that reasons for listing for particulars thereof do not need to be made available to someone searching the database 1.

It will be appreciated that many variations and modifications of the preferred embodiment of the system 10 can be provided. For example, the electronic message maybe sent by SMS, email or Instant Message, or automated telephone call or facsimile as desired. It will be appreciated any preferred electronic message can be used such as tweets or Facebook posts, for example. Further, although the database 1 is accessible over the internet 2 to registered tourist service providers 3; this need not be the case. A telephone subscription service may also be provided if desired to the searching tourist service provider.

In other preferred embodiments, not illustrated, database 1 is able to be searched or sorted as desired by registered tourist service providers 3. Such searching may be by the predetermined acceptable government issued identification numbers or via the name.

It will be appreciated that in preferred embodiments, the system 10 is configured only to list clients for a predetermined period of time. Practically, this predetermined period of time would be equivalent to law enforcement statute of limitations time periods for any particular alleged damage to have been caused by the listed client. However, it will be appreciated that the information need not be deleted or could be deleted sooner or later as desired.

Of course, the database 1 is also preferably configured to allow an entry created by a provider to be amended or cancelled such as to remove the listing if a listed client addresses the matter independently. Furthermore, it will be appreciated that a dispute resolution mechanism for listed delinquent clients can be provided. Such dispute resolution procedures may involve the use of retired judges or independent arbitration services, or the courts.

In other preferred embodiments of the invention, not illustrated, the system 10 can be configured to provide a reporting function or display section to registered tourist service providers indicative of all listings made by registered users within a predetermined, for example, the previous week or fortnight. Such a function may be called “Recent Listings”.

On a search screen of the system 10 available to registered users, when a registered user clicks on a toggle or tab entitled “Recent Listings” a dropdown list of those listed by all Members within their Economic Region (if the registered user has selected an economic region).

This feature of the system 10 is preferable and intended to provide a quick reference search to support a full or comprehensive search of database 1. This is expected to be of assistance in situations where a person has just left or been evicted from another nearby Accommodation Provider, and that person has moved quickly to gain a tenancy with another local Accommodation Provider in the hope that the former Accommodation Provider has not had insufficient time to list their former Client for any sort of alert.

In the preferred embodiments, an exemplary use would be by a Real Estate Agent who is registered with the system 10 and has:
given notice to quit to a recalcitrant Tenant with unfinished business, and
has listed the Tenant for ongoing contact.
If other Agents or Hostel Owners or Caravan Parks in the area are registered users of system 10, the “Recent Listings” search if used will forewarn them (most preferably for seven days after the listing) that the original evicting Real Estate Agent wishes to contact their former Tenant.
Presently, and in the case of typical practice in Australia, the evicting real Estate Agent may usually have to wait a couple of months to list the ex-Tenant as a defaulter.

As will be appreciated by a person skilled in the art, a proven defaulter (which can take months to establish and record in a Credit Bureau) is a different category from someone with whom the original Real Estate Agent simply wants to contact to discuss unfinished business.

Registered users of the system 10 would also preferably be advised to conduct comprehensive searches on new Clients even if they have access to a “Recent Listings” section as above. This will check for outstanding contact requests worldwide or if desired in a predefined economic region. It will also be appreciated that in preferred embodiments the registered users can check the “Recent Listings” quickly for local matters and does not require Passport, Drivers License or ID numbers to check as such can be conducted via a name.

The foregoing describes only one embodiment of the present invention and modifications, obvious to those skilled in the art, can be made thereto without departing from the scope of the present invention.

The term “comprising” (and its grammatical variations) as used herein is used in the inclusive sense of “including” or “having” and not in the exclusive sense of “consisting only of”.

1. A method of providing a rental service provider messaging system, the method comprising the steps of:
establishing a system database to receive registration details of rental service providers;
providing an interface for said registered rental service providers to enter details of any client required to contact said rental service provider wherein listed client details include particulars of predetermined acceptable government issued identification associated with that client;
configuring said database to be searched by any registered rental service provider when initially engaging with a client for any recorded entries for that client, said search including the particulars of details of predetermined acceptable government issued identification of the client; and
if said client is revealed in said database search, configuring said database to electronically message said registered rental service provider having listed said client on said database and advising said searching rental tourist service provider predetermined details of said client engaging the services of the searching rental tourist service provider.

2. A method according to claim 1 further including the step of alerting said rental service provider searching said database of the need for the listed client to contact the rental service provider having entered details of that client onto said database.

3. A method according to claim 1 wherein said registered rental service providers provide rental services selected from any one or more of the group consisting of: temporary accommodation; caravan parks; hotels; hostels; individual rental dwellings; boarding houses; motor vehicle or motorcycle; boat hire; bicycle hire; and hardware and tool hire; white goods and home wares and furniture rental; clothing and sporting and recreational equipment rental.

4. A method according to claim 1 wherein said acceptable government issued identification is selected from the group consisting of: passports; driver's licenses; and government issued identity documents or cards.

5. A method according to claim 1 wherein listed client details entered into said database further includes known or typical misspellings and abbreviations of name and/or known aliases and/or photographs.

6. A method according to claim 1 wherein registered rental providers searching said database and locating a listed client are provided with information on how to contact the registered rental provider who listed the client.

7. A method according to claim 1 wherein said electronic message sent to said registered rental service provider having listed said client on said database is sent in the form of one or more selected from the group consisting of: email; SMS; MMS; IM; automated telephone call or facsimile message; social media post or other electronic message type.

8. A method according to claim 1 wherein said electronically sent message includes identification details of the listed client, and the name, location and contact details of the rental provider searching the database and finding the listed client.

9. A method according to claim 1 wherein said database is able to be searched and/or sorted by registered rental service providers.

10. A method according to claim 1 further including the step of providing a mechanism for a listed client to dispute their listing in said database.

11. A method according to claim 1 further including the step of configuring said database such that a registered rental provider can delete or amend any client listings made by that registered provider.

12. A method according to claim 1 wherein said database is accessible to registered rental providers electronically via the internet.

13. A method according to claim 1 wherein the step of alerting said rental service provider searching said database of the need for the client to contact the rental service provider having entered details of said client onto said database includes identification details of the rental provider listing the client, and preferably their contact details and/or the basis for the listing of the client.

14. A rental service provider messaging system comprising:
a system database configured to receive registration details of rental service providers;
configuring said database for said registered rental service providers to enter details of any client required to contact said rental service provider wherein listed client details include particulars of predetermined acceptable government issued identification associated with that client;
configuring said database to be searched by any registered rental service provider when initially engaging with a client for any recorded entries for that client, said search including the particulars of details of predetermined acceptable government issued identification of the client; and
configuring said database to electronically message said registered rental service provider having listed said client on said database if said client is revealed in said database search, said electronic message advising said searching rental tourist service provider predetermined details of said client engaging the services of the searching rental tourist service provider.

15. A system according to claim 14 wherein the database is configured to generate an alert to said rental service provider searching said database of the need for said listed client to contact the rental service provider having entered details of that client onto said database.

16. A system according to claim 14 wherein said registered rental service providers provide rental services selected from any one or more of the group consisting of: temporary accommodation; caravan parks; hotels; hostels; individual rental dwellings; boarding houses; motor vehicle or motorcycle; boat hire; bicycle hire; and hardware and tool hire; white goods and home wares and furniture rental; clothing and sporting and recreational equipment rental.

17. A system according to claim 14 wherein said database is configured to provide populate data fields for a listed client with known or typical misspellings and abbreviations of their name and/or known aliases and/or photographs.

18. A system according to claim 14 wherein said electronic message sent to said registered rental service provider having listed said client on said database is sent in the form of one or more selected from the group consisting of: email; SMS; MMS; IM; automated telephone call or facsimile message; social media post or other electronic message type.

19. A system according to claim 14 wherein said database is configured to be searched and/or sorted by registered rental service providers.

20. A system according to claim 14 wherein said database is configured to receive notification from a listed client to dispute their listing or any details thereof in said database.

21. A method according to claim 14 wherein said database is accessible to registered rental providers electronically via the internet or via an electronic device.
